(19) United States
(12) Patent Application Publication
(10) Pub. No.: US 2004/0005527 A1
(43) Pub. Date: Jan. 8, 2004

(54) Protective barrier

(76) Inventor: Gregory Van Hale, Glendale, CA (US)

Correspondence Address: James E. Brunton, P. O. Box 29000, Suite 860, 700 North Brand Blvd., Glendale, CA, 91209, US

(21) Appl. No.: 10/189,691

(22) Filed: Jul. 3, 2002

(51) Int. Cl. A61C 1/16

(52) U.S. Cl. 433/116

(57) ABSTRACT

A protective barrier that can be removably fitted over a dental instrument to protect against the transfer of contaminants from one dental patient to another via the dental instrument. The protective barrier, which generally replicates the ergonomic features found on the outer surface of the dental instrument, is constructed from two mating segments that are adapted for placement over and in proximate contact with at least a portion of the outer surface of a dental instrument.

### BACKGROUND OF THE INVENTION

1. Field of the Invention

The present invention relates to protective barriers. More particularly, the invention relates to protective barriers for use with dental instruments to prevent the spread the contaminants.

It has long been recognized in the dental industry that after an infectious agent from one patient contaminates a dental instrument, the instrument has the potential to spread the contaminants to the next patient unless special care is taken to replace the instrument or properly sterilize it. As a general rule, replacing the instrument parts which are vulnerable to contamination is prohibitively expensive and sterilizing the parts by autoclaving is time consuming. While attempts have been made in the past to sterilize the instrument parts by spraying the parts with a disinfectant, experience has shown that such an approach is inadequate to effectively remove all contaminants.

In the past, various attempts have been made to provide protective plastic sheaths of various configurations for covering hand held dental tools. For example, U.S. Pat. No. 5,921,776, issued to Heilbrunn, discloses a barrier device that includes a disposable sheath, which can be positioned to shroud the instrument without encumbering its functionality. The device further includes a disposable probe which is integrally formed with the sheath and which is attached to the instrument along with the sheath.

2. Discussion of the Prior Art

In a similar vein, U.S. Pat. No. 4,907,968 issued to Eisner, et al. discloses a yieldably deformable shield or prophylactic, which exhibits sufficient deformability to adapt to any of a variety of angular or curved shapes of the nozzle of a dental syringe.

A common drawback of the prior art barrier devices resides in the fact that the dental instrument is more difficult to grip and to manipulate after the barrier device has been interconnected with the dental instrument. This is generally because the ergonomics provided on the dental instrument are covered and masked by the barrier device. Another drawback of the prior art barrier devices concerns the difficulty in initially attaching the barrier device securely to the dental instrument and then the removal of the barrier device from the dental instrument following completion of the dental procedure.

It is the drawbacks of the prior art devices as set forth in the preceding paragraph that the protective barrier of the present invention seeks to overcome. As will be better understood from the discussion that follows, the protective barrier device of the present invention is very easy to connect and disconnect from the dental instrument and uniquely replicates the ergonomics features found in the dental instrument. In one form of the invention the protective barrier device is fabricated from a moldable plastic that can be sterilized through use of appropriate antimicrobial liquids.

### SUMMARY OF THE INVENTION

It is an object of the present invention to provide a thin plastic protective barrier of novel design that can be removably fitted over a dental instrument to protect against the transfer of contaminants from one dental patient to another via the dental instrument.

Another object of the invention is to provide a protective barrier as described in the preceding paragraph in which the outer surface of the protective barrier generally replicates the ergonomic features found on the outer surface of the dental instrument.

Another object of the invention is to provide a protective barrier of the aforementioned character that is constructed from two mating segments that are adapted for placement over and in proximate contact with at least a portion of the outer surface of a dental instrument.

Another object of the invention is to provide a protective barrier of the type described in the preceding paragraph in which the two segments are releasably connected together by a first connector element provided on one of the segments and a second connector element provided on the other segment for locking engagement with said first connector element.

Another object of the invention is to provide a protective barrier of alternate construction in which the two segments are releasably connected together by a living hinge and also by a first connector element provided on one of the segments and a second connector element provided on the other segment for locking engagement with said first connector element.

Another object of the invention is to provide a protective barrier of the class described that is constructed from a moldable plastic that can be sterilized by soaking the protective barrier in an antimicrobial liquid.

Another object of the invention is to provide a protective barrier of the character described in the preceding paragraphs that is lightweight, durable and easy-to-use and one that permits positive gripping and control of the dental instrument during use.

Another object of the invention is to provide a protective barrier that can be inexpensively fabricated in quantity using well-known plastic molding techniques.

### BRIEF DESCRIPTION OF THE DRAWINGS

FIG. 1 is a side elevational view of a conventional type of slow speed dental hand piece with which the protective barrier device of the present invention can be used.

FIG. 2 is a side elevational view of a conventional type of high-speed dental hand piece with which the protective barrier device of the present invention can be used.

FIG. 3 is a side elevational view showing one form of the protective barrier device of the present invention interconnected with a slow speed dental hand piece of the character shown in FIG. 1.

FIG. 4 is a side elevational exploded view showing the two segments of the protective barrier device separated from the slow speed dental hand pace.

FIG. 5 is a cross-sectional view taken along lines 5-5 of FIG. 3.

FIG. 6 is a greatly enlarged, cross-sectional view of the area designated in FIG. 5 by the numeral 6.

FIG. 7 is a side elevational view showing an alternate form of the protective barrier device of the invention interconnected with a slow speed dental hand piece of the character shown in FIG. 1.

FIG. 8 is a plan view of the protective barrier device shown in FIG. 7 as it appears in an open position.

FIG. 9 is a view taken along lines 9-9 of FIG. 8.

FIG. 10 is a cross-sectional view taken along lines 10-10 of FIG. 8.

FIG. 11 is a cross-sectional view taken along lines 11-11 of FIG. 8.

FIG. 12 is a side elevational view showing an alternate form a protective barrier device interconnected with a prior art high-speed hand piece of the character shown in FIG. 2.

FIG. 13 is a plan view of the protective barrier device shown in FIG. 12 as it appears in open position.

FIG. 14 is a cross-sectional view taken along lines 14-14 of FIG. 12.

FIG. 15 is a cross-sectional view taken along lines 15-15 of FIG. 12.

FIG. 16 is enlarged cross-sectional view of the connector elements of the protective barrier device shown in FIG. 14 that function to interconnect the two segments of the device as shown in FIG. 13.

### DESCRIPTION OF THE INVENTION

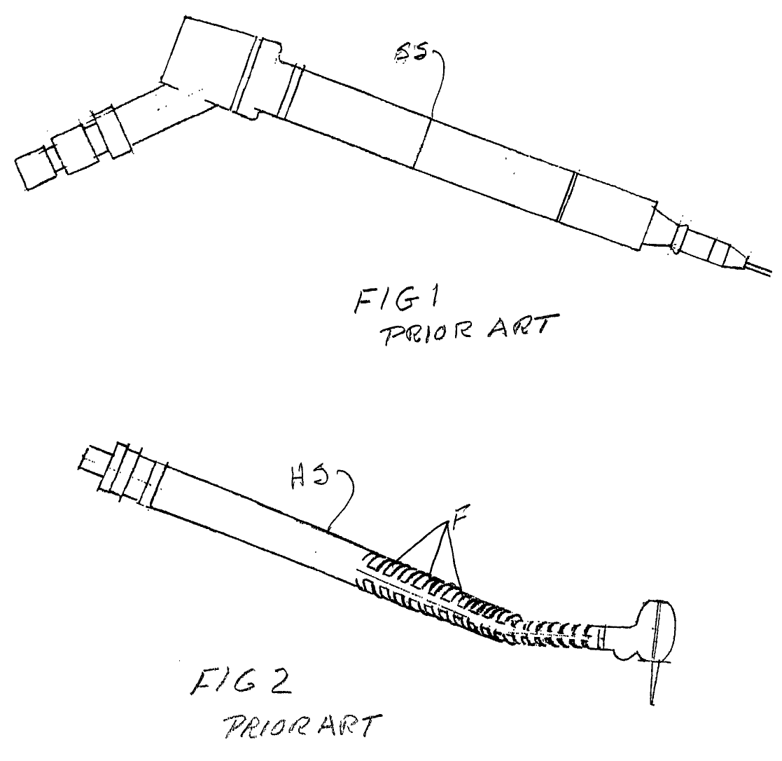

Referring to the drawings and particularly to FIGS. 1 and 2, two types of prior art dental instruments of the type with which the protective barrier devices of the present invention can be used are there shown. In FIG. 1 a slow speed dental hand piece “SS” is illustrated and in FIG. 2 a high-speed dental hand piece “HS” is shown. It is be understood that these hand pieces are merely exemplary of the many different types of dental instruments with which the barrier devices of the present invention can be used. For example, the protective barriers of the invention can be specially constructed for use with aspirating units of various designs, dental drills of various designs, scalars, saliva ejector instruments and air/water supply instruments.

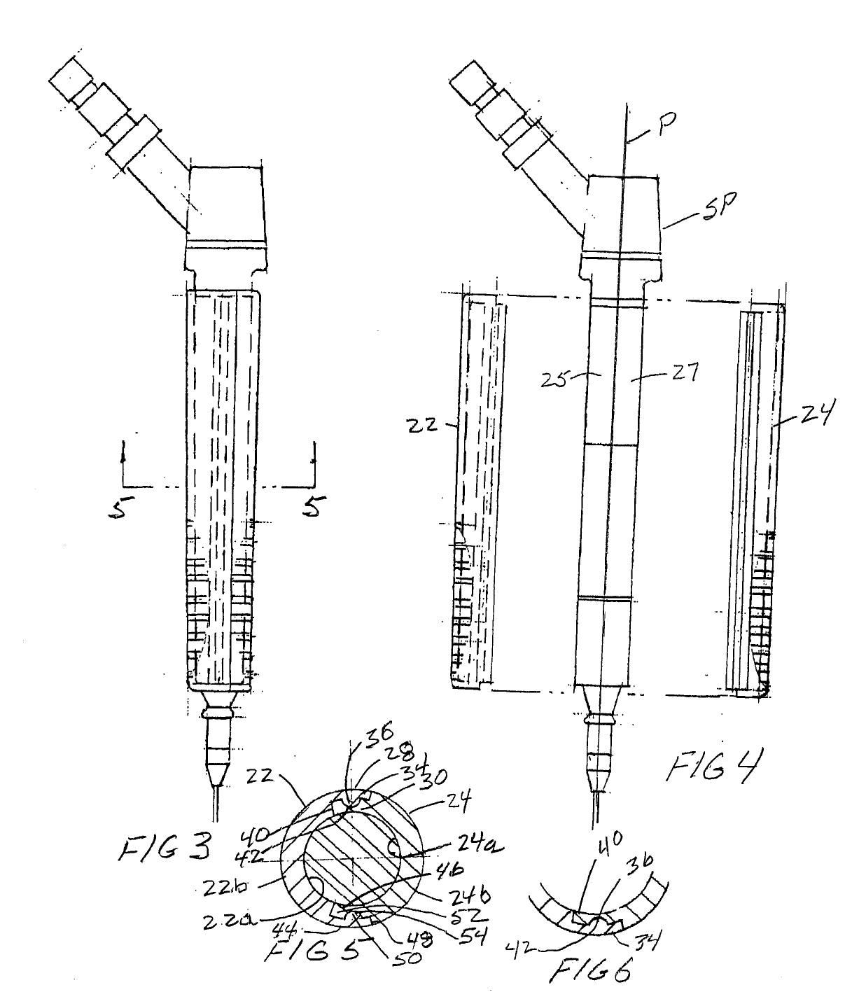

Turning to FIGS. 3 through 6, one form of protective barrier device of the invention is there shown for use in connection with a slow speed dental instrument SS of the character shown in FIG. 1. This protective barrier is designed for placement over and in proximate contact with the outer surface of the handle portion of the dental instrument. However, it is to be understood that the protective barrier could also be constructed for placement over and in proximate contact with all or part of the dental instrument shown in FIG. 1. In the embodiment of the invention shown in FIGS. 3 through 6, the protective barrier, which is constructed from two semicircular shaped, substantially rigid half segments, comprises a relatively thin, first elongated segment 22 having an inner surface 22a and a spaced apart outer surface 22b (FIG. 5) and a second relatively thin, elongated segment 24 that can be removably connected to first segment 22 in a manner presently to be described. Second segment 24 has a curved inner surface 24a and a spaced apart curved outer surface 24b (FIG. 5). Segments 22 and 24 can be of various thicknesses, but preferably have a thickness of between about 0.020 and about 0.1 inch. An important feature of the protective barrier of this form of the invention is that the outer surface of the protective barrier substantially replicates the outer surface of the dental instrument SS. More particularly, where the outer surface of the dental instrument comprises first and second adjoining curved segments 25 and 27 which together form the outer surface of the instrument, the adjoining segments being disposed on opposite sides of the axially extending plane P shown in FIG. 4, the outer surface of first segment and 22 substantially replicates the outer surface of curved segment 25. Similarly, the outer surface of second segment 24 substantially replicates the outer surface of curved segment 27. In the embodiment of the invention shown in FIGS. 3 through 6, the inner surface of the protective barrier in also substantially replicates the outer surface of the dental instrument. This is accomplished by injection molding the first and second segments 22 and 24 from a moldable plastic using an injection mold in which both sides of the mold cavity substantially replicate the outer surface of the dental instrument. In this regard, it is to be understood that the mold cavity is constructed so that the internal dimensions of the first and second segments 22 and 24 are slightly larger than the external dimension of the outer surfaces 25 and 27 of the dental instrument. In this way some clearance is provided between of the protective barrier and the dental instrument. However, the clearance is small enough so that the protective barrier will not shift relative to the dental instrument during the performance of the dental procedure. Because the ergonomic features provided on the dental instrument are replicated on the outer surface of the protective barrier, the dentist, or dental technician can securely grip the protective barrier and readily manipulate it in the same manner as the dental instrument could be manipulated without the addition of the protective barrier.

As best seen by referring to FIGS. 3, 5 and 6, the protective barrier of this form of the invention also includes connector means for interconnecting first and second segments 22 and 24. The connector means here comprises a first connector element 28 provided on first segment 22 and a second connector element 30 provided on said second segment 24. The first and second connector elements extend along the edge of the first and second segments and, as shown in FIG. 6, connector element 28 comprises a tongue-like member 34 having a protuberance 36 formed thereon. Connector element 30 similarly comprises a tongue-like member 40 having a groove 42 formed therein for closely receiving protuberance 36 of tongue like member 34.

As indicated in FIGS. 4 and 5, the connector means further comprises a third connector element 44 provided on first segment 22 and a fourth connector element 46 provided on said second segment 24. The third and fourth connector elements 44 and 46 extend along the edge of the first and second segments. As shown in FIG. 5, connector elements 44 and 46 are of substantially identical construction to connector elements 40 and 42. More particularly, connector element 44 comprises a tongue-like member 48 having a protuberance 50 formed thereon. Connector element 46 similarly comprises a tongue-like member 52 having a groove 54 formed therein for closely receiving protuberance 50 of tongue-like member 48.

With the construction shown in the drawings and described in the preceding paragraphs, segments 22 and 24 can be positioned about the dental instrument SS in a manner shown in FIG. 3 and, using the connection means, can be snapped together in a manner to securely hold the segments in close proximity with the barrel portion of the dental instrument. At the completion of the dental procedure, the segments can be readily separated and either discarded in favor of new protective barrier segments or alternatively can be sterilized in an appropriate antimicrobial liquid.

Turning next to FIGS. 7 through 11, an alternative form of protective barrier device of the invention is there shown also for use in connection with a slow speed dental instrument SS of the character shown in FIG. 1. This protective barrier is similar in many respects to the earlier described protective barrier and is designed for placement over the outer surface of the handle portion of the dental instrument. As before, the protective barrier could also be constructed for placement over all or part of the dental instrument shown in FIG. 1. In the embodiment of the invention shown in FIGS. 7 through 11, the protective barrier, which is also constructed from two thin plastic half segments, does not replicate the outer surface of the dental instrument, but rather is provided with specially designed ergonomic features that will assist the dentist or dental technician in griping in manipulating the dental instrument. As in the earlier described embodiment, the protective barrier of this latest form of the invention comprises a first elongated segment 62 having an inner surface 62a and a spaced apart outer surface 62b (FIG. 9) and a second elongated segment 64 that is connected to first segment 62 by means of a living hinge 66 (FIGS. 8 and 9). Second segment 64 has a curved inner surface 64a and a spaced apart curved outer surface 64b (FIG. 9). As earlier mentioned, an important feature of the protective barrier of this latest form of the invention is that the outer surface of the protective barrier is provided with its own ergonomic features. More particularly, the outer surface of the protective barrier is provided with a pair of spaced apart recessed areas generally designated in FIG. 7 by the numerals 68 and 70. Additionally, the protective barrier is provided with a plurality of longitudinally spaced apart ribs 72 that assist the dentist or dental technician in gripping the lower portion of the protective barrier. While the inner surface of the protective barrier of this latest form of the invention may, if desired, substantially replicate the outer surface of the dental instrument, the protective barrier is here formed in a manner such that only the portions of the protective barrier adjacent recessed areas 68 and 70 and the portions of the barrier located adjacent its extremities are disposed in close proximity with the barrel of the dental instrument. Once again, the protective barrier is preferably formed from a moldable plastic using either injection molding, or other suitable molding techniques of a character well known to those skilled in the art.

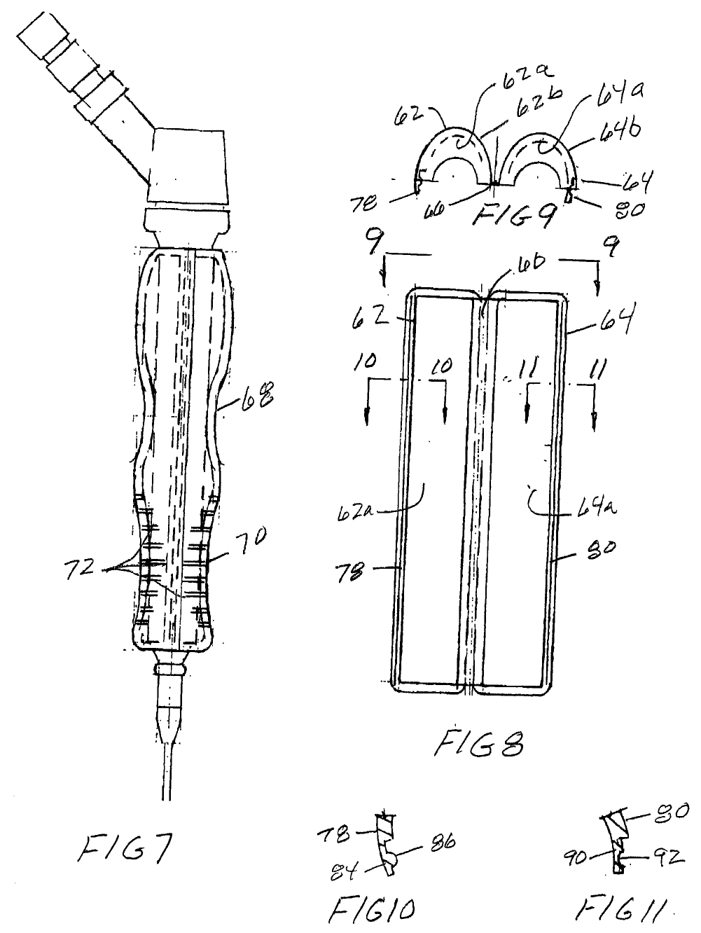

The connector means of this latest form of the invention comprises, in addition to living hinge 66, a first connector element 78 provided on first segment 62 and a second connector element 80 provided on said second segment 24. The first and second connector elements extend along the edges of the first and second segments and, as shown in FIG. 10, connector element 78 comprises a tongue-like member 84 having a protuberance 86 formed thereon. Connector element 80 similarly comprises a tongue-like member 90 having a groove 92 formed therein for closely receiving protuberance 86 of tongue like member 84.

With the construction of shown in the drawings and described in the preceding paragraphs, segments 62 and 64 can be positioned about the dental instrument SS by pivoting the segments relative to one another about the living hinge 60 from a position shown in FIG. 9 to the position shown in FIG. 7. When the segments reach the closed position they can be snapped together using the connection mean so as to securely hold the segments in position about the barrel portion of the dental instrument. As in the earlier described embodiment, when the dental procedure is completed, the segments can be readily separated and either discarded in favor of new protective barrier segments or alternatively can be sterilized in an appropriate antimicrobial liquid.

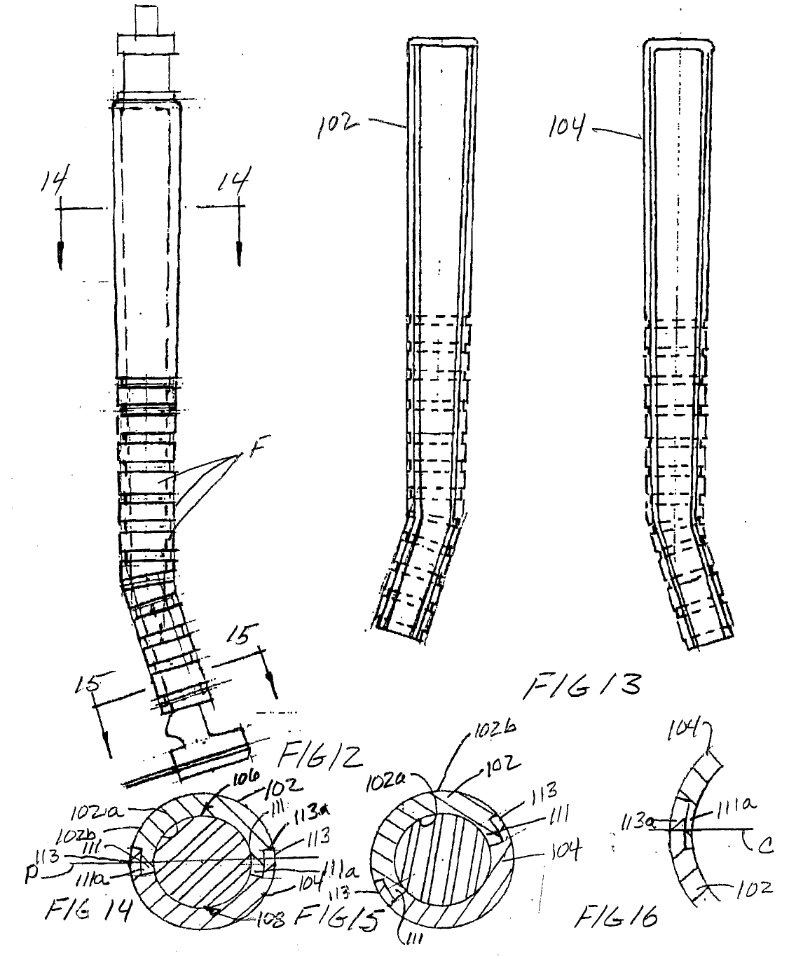

Referring now to FIGS. 12 through 16, still another form of protective barrier device of the invention is there shown for use in connection with a high speed dental instrument HS of the character shown in FIG. 2. This latest protective barrier is similar in many respects to the previously described protective barriers and is specifically designed for placement over and in proximate contact with substantially the entire outer surface of the body portion of a dental instrument of the character shown in FIG. 2 of the drawings.

In the embodiment of the invention shown in FIGS. 12 through 16, the protective barrier, which is also constructed from two thin plastic half segments, comprises a first elongated segment 102 having an inner surface 102a and a spaced apart outer surface 102b (FIG. 14) and a second elongated segment 104 that is removably connected to first segment 102 in a manner presently be described.

An important feature of the protective barrier of this latest form of the invention is that the outer surface of the protective barrier substantially replicates the outer surface of the dental instrument HS. More particularly, where the outer surface of the dental instrument comprises first and second adjoining curved segments 106 and 108 (FIG. 14), which together form the outer surface of the instrument and which are disposed on opposite sides of an axially extending plane P as shown in FIG. 14, the outer surface of first segment and 102 substantially replicates the outer surface of curved segment 106. Similarly, the outer surface of second segment 104 substantially replicates the outer surface of curved segment 108. In the embodiment of the invention shown in FIGS. 12 through 16, the inner surface of the protective barrier also substantially replicates the outer surface of the dental instrument HS. As in the earlier described embodiments, this is accomplished by injection molding or the like, the first and second segments 102 and 104 from a moldable plastic using a mold in which both sides of the mold cavity substantially replicate the outer surface of the dental instrument. In this regard, it is to be understood that, once again the mold cavity is preferably constructed so that the internal dimensions of the first and second segments 102 and 104 are slightly larger than the external dimension of the outer surfaces 106 and 108 of the dental instrument. In this way some clearance is provided between the protective barrier and the dental instrument. However, the clearance is small enough so that the protective barrier will not shift relative to the dental instrument during the performance of the dental procedure. Because the ergonomic features, such is the features “F” (FIG. 2) provided on the dental instrument are replicated on the outer surface of the protective barrier, the dentist, or dental technician can securely grip the protective barrier and manipulate the protective device in the same manner as the dental instrument could be manipulated without the addition of the protective barrier.

As best seen by referring to FIGS. 14, 15 and 16, the protective barrier of this latest form of the invention also includes connector means for interconnecting the first and second segments 102 and 104. The connector means here comprise a first connector element 111 provided on each edge first segment 102 and a second connector element 113 provided on each edge of second segment 104. The first and second connector elements extend along the edges of the first and second segments and, as shown in FIG. 6, each of the connector elements 111 comprises a first locking extension 111a. Each of the connector elements 113 similarly comprises a second locking extension 113a, which is adapted to lockably mate with first locking extensions 111a.

With the construction shown in the drawings and described in the preceding paragraphs, segments 102 and 104 can be positioned about the dental instrument HS in a manner shown in FIG. 12 and, using the connection means, snapped together so as to securely hold the segments in close proximity with the barrel portion of the dental instrument. As best seen by referring to FIG. 16, when the segments 102 and 104 are positioned about the dental instrument, the first and second locking extensions 111a and 113a overlap the centerline “C” of the device and, because of their novel configuration, provide a secure interconnection of the segments. At the completion of the dental procedure, the segments can be readily separated and either discarded in favor of new protective barrier segments or alternatively can be sterilized in an appropriate antimicrobial liquid.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following documents.

I claim:

1. A protective barrier for placement over and in proximate contact with at least a portion of the outer surface of a dental instrument, said outer surface of said dental instrument comprising first and second adjoining segments, said protective barrier comprising:
(a) a first substantially rigid segment having an inner surface and a spaced apart outer surface; and
(b) a second substantially rigid segment connected to said first segment, said second segment having an inner surface and a spaced apart outer surface.

2. The protective barrier as defined in claim 1 in which said outer surface of said first segment generally replicates the surface of the first segment of the outer surface of the dental instrument and in which said outer surface of said second segment generally replicates the surface of the second segment of the outer surface of the dental instrument.

3. The protective barrier as defined in claim 1 in which said inner surface of said first segment generally replicates the surface of the first segment of the outer surface of the dental instrument and in which said inner surface of said second segment generally replicates the surface of the second segment of the outer surface of the dental instrument.

4. The protective barrier as defined in claim 1 in which the internal dimensions of said first and second segments are slightly larger than the external dimension of the outer surface of the dental instrument.

5. The protective barrier as defined in claim 1 further including connector means for interconnecting said first and second segments.

6. The protective barrier as defined in claim 5 in which said connector means comprises a first connector element provided on said first segment and a second connector element provided on said second segment, said first connector element being in locking engagement with said second connector element.

7. The protective barrier as defined in claim 5 in which said connector means comprises:
(a) a living hinge interconnecting said first and second segments;
(b) a first connector element provided on said first segment; and
(c) a second connector element provided on said second segment for locking engagement with said first connector element.

8. A removable protective barrier for placement over and in proximate contact with at least a portion of the outer surface of a dental instrument, said outer surface of said dental instrument comprising first and second adjoining segments, said protective barrier comprising:
(a) a first segment having an inner surface and a spaced apart outer surface, said outer surface generally replicating said surface of first segment of said outer surface of said dental instrument;
(b) a second segment connected to said first segment, said second segment having an inner surface and a spaced apart outer surface, said outer surface generally replicating said surface of second adjoining segment of said outer surface of said dental instrument; and
(c) connector means for interconnecting said first and second segments.

9. The protective barrier as defined in claim 8 in which said inner surface of said first segment generally replicates the surface of the first segment of the outer surface of the dental instrument and in which said inner surface of said second segment generally replicates the surface of the second segment of the outer surface of the dental instrument.

10. The protective barrier as defined in claim 8 in which the internal dimensions of said first and second segments are slightly larger than the external dimension of the outer surface of the dental instrument.

11. The protective barrier as defined in claim 8 in which said connector means comprises a first connector element provided on said first segment and a second connector element provided on said second segment, said first connector element being in locking engagement with said second connector element.

12. The protective barrier as defined in claim 8 in which said connector means comprises:
(a) a living hinge interconnecting said first and second segments;
(b) a first connector element provided on said first segment; and
(c) a second connector element provided on said second segment for locking engagement with said first connector element.

13. A removable, thin plastic protective barrier for placement over and in proximate contact with at least a portion of the outer surface of a dental instrument, said outer surface of said dental instrument comprising first and second adjoining segments, said protective barrier comprising:
(a) a first segment having an inner surface and a spaced apart outer surface, said outer surface generally replicating said surface of first segment of said outer surface of said dental instrument;
(b) a second segment connected to said first segment, said second segment having an inner surface and a spaced apart outer surface, said outer surface generally replicating said surface of second adjoining segment of said outer surface of said dental instrument; and
(c) connector means for interconnecting said first and second segments, said connector means comprising a first connector element provided on said first segment and a second connector element provided on said second segment, said first connector element being in locking engagement with said second connector element.

14. The protective barrier as defined in claim 13 in which said inner surface of said first segment generally replicates the surface of the first segment of the outer surface of the dental instrument and in which said inner surface of said second segment generally replicates the surface of the second segment of the outer surface of the dental instrument.

15. The protective barrier as defined in claim 13 in which the internal dimensions of said first and second segments are slightly larger than the external dimension of the outer surface of the dental instrument.

16. The protective barrier as defined in claim 13 in which said connector means further comprises a living hinge interconnecting said first and second segments.

17. The protective barrier as defined in claim 13 in which said first and second segments are injection molded from a moldable plastic.

18. The protective barrier as defined in claim 1 in which said first and second segments have a thickness of between about 0.020 and about 0.10 inch.
